(19) United States
(12) Patent Application Publication
(10) Pub. No.: US 2008/0244563 A1
(43) Pub. Date: Oct. 2, 2008

(54) Dynamic configuration environment for setup

(75) Inventors: Dmitry Sonkin, Redmond, WA (US); Unmesh Vartak, Redmond, WA (US); Edward Tremblay, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/728,369

(22) Filed: Mar. 26, 2007

(51) Int. Cl. G06F 9/445

(52) U.S. Cl. 717/175

(57) ABSTRACT

A setup or installation operation is divided into discrete task components, each of which has a data input. The data input may be in the form of an information file that is populated by user input, discovery routines, or from predefined data. When an installation is successfully completed, the information file may be saved and be used to track a configuration history. The same information file may be used for a silent setup where an installation operation may be executed without any user input. The setup system may be extensible by adding additional discrete task components and extending the information file to include data used by the additional components.

### BACKGROUND

Setup and installation of operating systems and other complex computer applications may be quite complex and may also have several variations or configurations. In many systems, an operating system or computer application may have different features that may be added or removed to define a specific configuration. New features may also be added at a later date.

In some installation systems, a user may need to re-enter data to perform a new installation. A new installation may be on the same system as an original installation, or may be on a second system that is a duplicate of the first. When a user has to reenter data, there is an opportunity for mistyping or other mistakes as well as the time required for the reentry.

### SUMMARY

A setup or installation operation is divided into discrete task components, each of which has a data input. The data input may be in the form of a configuration file that is populated by user input, discovery routines, or from predefined data. When an installation is successfully completed, the configuration file may be saved and be used to track a configuration history. The same configuration file may be used for a silent setup where an installation operation may be executed without any user input. The setup system may be extensible by adding additional discrete task components and extending the configuration file to include data used by the additional components.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram of an embodiment showing a system with an interactive setup manager.

FIG. 2 is a flowchart of an embodiment showing a method of operation for an interactive setup manager.

FIG. 3 is a diagram of an embodiment showing a system with a silent setup manager.

FIG. 4 is a flowchart of an embodiment showing a method of operation for a silent setup manager

FIG. 5 is a diagram of an embodiment showing a file structure for files used by a setup manager.

FIG. 6 is a flowchart of an embodiment showing a method of adding setup tasks to an existing installation.

### DETAILED DESCRIPTION

An architecture for a setup or installation routine uses data-driven tasks, where the data are stored in a configuration file. The architecture can be used for conventional installation sequences where a user is prompted for various data used during installation, as well as a silent install where the installation is performed without user interaction.

Because the configuration file includes the data sent to each setup task, the configuration file may be a complete definition of the installation. By saving a new configuration file each time an installation is performed, a history of installations may be created. The history may be useful in noting changes between versions.

The setup routine may be expanded and modified. In order to add a task for setup, the configuration file may be edited to add data for the new task. Similarly, the new task may be added to a sequence file that defines tasks to be performed. An interactive setup manager may be executed that performs the new task and appends data for the new task to the configuration file.

A discovery mechanism may be used to discover hardware and software parameters about a device and create an initial configuration file for a setup routine. The initial configuration file may be modified with user input to result in a configuration file that defines the first installation or setup.

The setup architecture may be used for installing operating systems, applications, or software components. In some embodiments, the setup architecture may be used as an installation or setup application for any installed component or application. In other embodiments, some applications may use the setup architecture while other applications may use a different installation or setup mechanism.

For the purposes of this specification, the terms “installation” and “setup” are used synonymously to refer to a process of putting a program, operating system, application, or other software component on a system so that the software may be used. In some instances, the installation process may be installing data files that are not executed, while in other instances, the process may include installing executable or interpretable software functions or programs.

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the invention as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

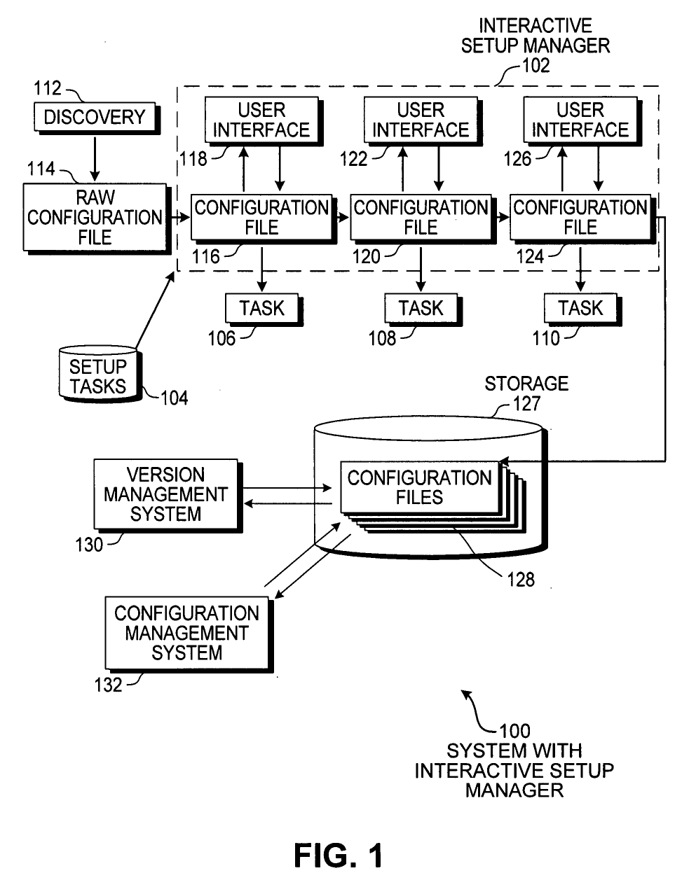

FIG. 1 is a diagram of an embodiment 100 showing a system with an interactive setup manager. An interactive setup manager 102 uses a predefined set of setup tasks 104 to cause tasks 106, 108, and I 10 to be performed.

The interactive setup manager 102 may be used to install or setup various software products, including operating systems, applications, and various software components. In some embodiments, the interactive setup manager 102 may be used for installing a group of related or unrelated software products and may even be used to manage all installation actions on a system.

The interactive setup manager 102 may operate on a device such as a personal computer, server computer, or other computing platform that uses installed software components. In some instances, the interactive server manager 102 may operate on a personal digital assistant, media player, game console, mobile telephone, industrial controller, or other such device. In some cases, the interactive setup manager may operate over a network to install various components or software systems on a remote device.

The interactive setup manager 102 may use a list of setup tasks 104 to define its operation. By defining the setup tasks 104 in a separate file or other storage mechanism, the interactive setup manager 102 may be easily adapted to many different setup tasks. In many cases, the setup tasks 104 may be a user editable file in various formats, such as XML. The interactive setup manager 102 interprets the setup tasks 104 to cause the various tasks 106, 108, and 110 to be executed.

Because the sequence of setup steps is defined in a file, additional steps may be added at a later time. In some embodiments, additional steps may be added after some of the previous steps have been completed. The complete sequence of steps and data used to execute the various tasks can be used as a record of the installation or setup for a device. In some instances, the sequence of steps and data may be used on a second device to create an identical installation.

The tasks 106, 108, and 110 may be any task that may be part of a setup or installation sequence. The tasks 106, 108, and 110 may be executable files that perform a specific task or may be scripts or other interpreted definition of an action to be taken.

The tasks 106, 108, and 110 may be defined in a manner so that the individual task may be called or executed with data input. In many embodiments, the tasks 106, 108, and 110 may be operated without user input. Such a design may enable the sequence of tasks to be executed without user input in some instances.

When the tasks 106, 108, and 110 use a data input, several different mechanisms may be used to create the data. For example, a first user interface may be created for users in a first language and a second user interface for users of a second language. Regardless of the user interface, the data sent to the tasks 106, 108, and 110 is the same.

Other data sources may be used to create data for the tasks 106, 108, and 110. For example, a discovery tool 112 may examine various hardware and software components of a system and create a raw configuration file 114 that includes some or all of the data used by the various tasks. In another example, a configuration file may be created by exporting from a previous successful installation. In yet another example, a configuration file may be created or modified by a configuration management system 132 that may monitor changes to a system configuration.

In some embodiments, the discovery tool 112 may examine hardware and software components to determine at least some starting parameters for an installation routine. In some instances, the discovery tool 112 may be capable of determining all parameters in a configuration file for the component, while in other instances, the discovery tool 112 may determine a portion of the data. In some cases, the discovered data may be presented to a user for modification, while in other cases, the data may be protected from user modification.

The interactive setup manager 102 may use a configuration file and execute the various tasks defined in the setup tasks 104. The interactive setup manager 102 may evaluate a version of a configuration file 116 and interact with the configuration file 116 with a user interface 118. After modifying the configuration file 116, the task 106 may be executed.

The user interface 118 may interact with the configuration file 116 to enable a user to change or set various parameters. In some embodiments, the user interface 118 may read variables or other data from the configuration file 116 and display some or all of those variables within the user interface 118. For example, a text box or other interactive component may be used in the user interface 118 for an address of a network gateway. The user interface 118 may receive an address from the configuration file 116 and present the address within the text box. The user may be able to edit the address or leave the address alone. Different user interfaces may display data and receive user data in many different forms and using many different mechanisms.

Once the user interface 118 has updated the configuration file 116, the data from the configuration file 116 may be sent to the task 106 when the task is started. In some instances, the task 106 may be instantiated or executed and then the data may be transmitted, while in other instances the data may be transmitted simultaneously or prior to starting the task 106. In still other instances, the task 106 may be started and the task 106 may read the configuration file 116 directly to retrieve data.

The tasks 106, 108, and 110 may be any type of task definition that performs an intended task. In some cases, the task 106 may be an executable program that is called from the interactive setup manager 102. In other cases, the task 106 may be a script or other interpreted definition that is interpreted by a separate executable program.

The tasks 106, 108, and 110 may be any portion of a setup or installation routine. In some instances, one task may install a complete application, suite of applications, subsystem, or component. In other instances, each task may perform a small, granular task that is a small portion of installing an application or component. Each embodiment may define the scope and function of each task differently. In some cases, tasks may be defined based on different software options that may be collected together to form an application, different hardware configurations that may be supported, or any other reason.

After task 106 has been launched, the configuration file 120 may contain data from the configuration file 116 plus any additional data or changes that may be input from the user interface 118. In a similar manner, user interface 122 may interact with the configuration file 120. Once the interaction is complete, the data are transferred to the task 108 which is launched. In a similar manner, the updated configuration file 124 is modified by the user interface 126 and the data is used to launch task 110.

The configuration file 124 may have several sections, with each task 106, 108, and 110 having a separate section within the configuration file 124. The configuration file 124 may also have a common area for global data or data that are shared across two or more tasks. In many cases, the configuration file 124 may be a human readable and editable format, such as XML.

The interactive setup manager 102 illustrates how individual tasks may be prepared and launched. In the embodiment 100, each task 106, 108, and 110 may have a separate user interface 118, 122, and 126, respectively. In many embodiments, a task may have a user interface that is separate from other tasks. Such an embodiment may make it easier to remove a task or add a task, since each task may have a separate user interface and removing one task may not adversely affect other user interfaces.

The user interfaces 118, 122, and 126 may be a single screen or window presented to a user. In other embodiments, a sequential user interface such as a wizard may be used to present and collect data to a user. Some embodiments may use two or more windows or screen layouts. In still other embodiments, an interactive user interface may allow a user to browse or interact with data in any manner imaginable, including expanding and contracting hierarchical lists or any other mechanism. In some embodiments, multiple user interfaces may be used for a single task. For example, a task may have two or more user interface screens or windows that are used to present and collect data for a particular task. In such an example, one screen may be various data elements presented in a spreadsheet fashion while an alternative user interface may use a wizard to present, edit, and collect the same information.

After the configuration file 124 has been modified and used to perform the various tasks 106, 108, and 110, the configuration file 124 may contain all of the data used to configure a system. As such, the configuration file 124 may act as a record of the installation or setup process.

The configuration file 124 is stored in the storage system 127 as a recent configuration. The version management system 130 may track different versions of configuration files and may be adapted to determine when a particular feature, application, or component was installed, or provide a known good configuration file from a successful installation. Such data may be determined by comparing one configuration file with another. Such a known good configuration file may be transferred to a new system and used to configure the new system identically to the first system.

The configuration management system 132 may monitor hardware and software changes to a system and update a configuration file to reflect the change. In some instances, the configuration management system 132 may detect a change, update a configuration file 128, and execute a silent setup manager to reconfigure a system based on the detected change.

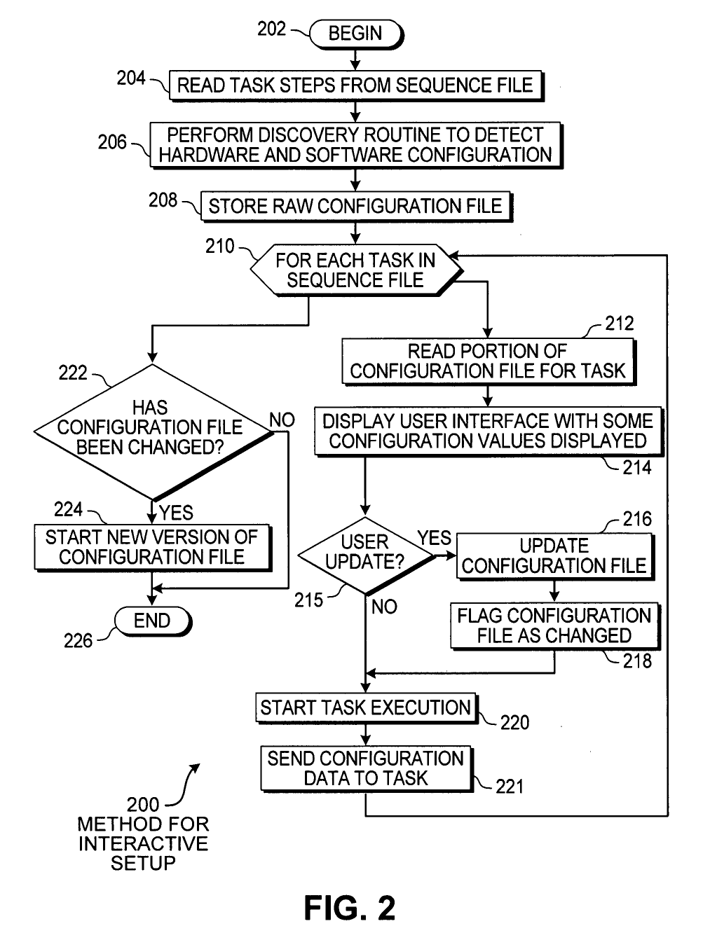

FIG. 2 is a flowchart illustration of an embodiment 200 showing a method for interactive setup. The process begins in block 202. Task steps are read from a sequence file in block 204.

A discovery routine is performed in block 206 to detect hardware and software configuration. The results of the discovery routine are stored in a raw configuration file in block 208. In some embodiments, the raw configuration file may be a partially populated configuration file that contains some of the data used for the various tasks. In other embodiments, the raw configuration file may contain detected data and default settings that may be sufficient to enable a successful installation or setup to be completed. The data collected in the raw configuration file may be limited to the detail that a discovery routine may be able to ascertain about an existing hardware or software configuration.

The discovery routine may detect the presence of devices or subcomponents within a system and may be capable of querying such devices or subcomponents to determine various data. The data used in a configuration file may include data obtained directly from a hardware component as well as data referenced from a lookup table, local database, or remote database using data from the hardware device.

Similarly, a discovery routine may be able to detect the presence and configuration of various software components. The discovery routine may be able to query operating software components to determine the presence and various data about the component. Additionally, the discovery routine may be able to examine a data storage system such as a hard disk drive to determine that a particular software application or component has been installed. The discovery routine may be capable of examining data files, registry settings, or other data to determine particular settings or other data about installed software components.

For each task in the sequence file in block 210, the following steps are performed: a portion of the configuration file for the task is read in block 212, and a user interface is displayed with some of the configuration values displayed in block 214. If the user updates the data in block 215, the configuration file is updated in block 216 and the configuration file is flagged as changed in block 218. The task is started in block 220 and the configuration data is sent to the task in block 221.

The method from blocks 212 to 221 may be performed for each step within the sequence file. The method presents existing data from a configuration file to a user, allows a user to edit the data, and starts the particular task with the updated data. In many user interfaces, data from an existing configuration file may be presented to a user for editing. In some instances, the user may not need to edit or change the data and then accept the data as presented.

The data presented to a user in block 214 may come from the raw configuration file in block 208. In some instances, the raw configuration file of block 208 may not have data in certain data fields that are used by a task. In such an instance, the user may be forced to enter an acceptable value for the data before the task may be launched.

The task execution is started in block 220 and data is passed to the task in block 221. In other embodiments, the data may be transferred to the task prior to executing the task, such as by writing a data file that is read by the task or some other mechanism. The task executed in block 220 may or may not be part of a setup manager. In some embodiments, the various tasks may be standalone applications or executable programs that function independently from a setup manager. In other embodiments, the various tasks may be a subroutine, object, or other function that operates within the setup manager.

If the user updates the configuration data in block 215, the configuration file is updated in block 216 and flagged as changed in block 218. After each task has been evaluated, if the configuration file has been changed in block 222, a new version of the configuration file is stored in block 224 and the process ends in block 226. If no changes are made to the configuration file in block 222, the process ends in block 226.

A new version of the configuration file may be stored each time a successful installation sequence is performed and the data are changed. The different configuration files may serve as an installation history and may be used for many different purposes, including reviewing operational history of a device, comparing one version to another to determine changes between installations, finding a successfully executed installation for use on a duplicate device, or other functions.

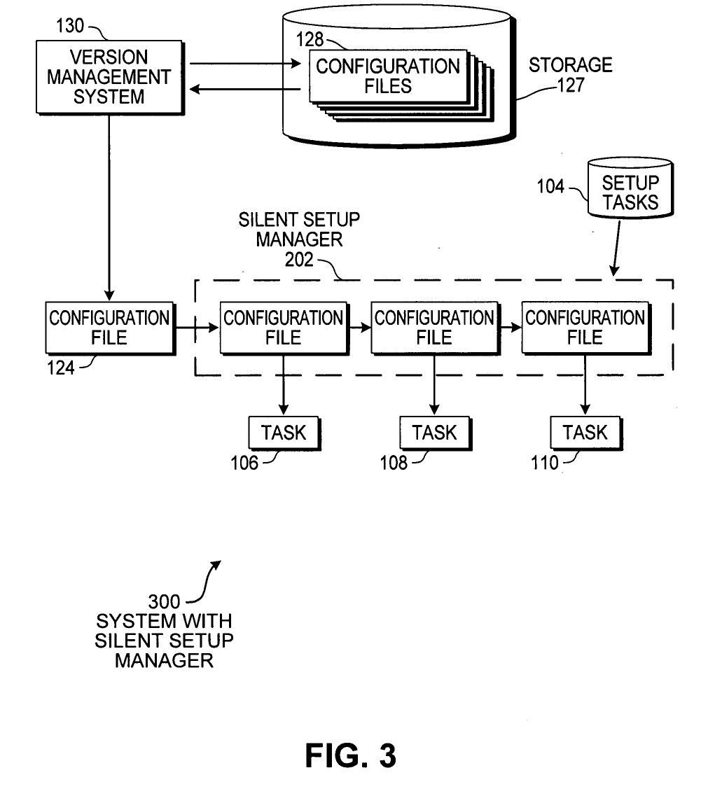

FIG. 3 is a diagram illustration of an embodiment 300 showing a system with a silent setup manager. The embodiment 300 is similar to embodiment 100 in that it performs identical tasks 106, 108, and 110 as embodiment 100. However, embodiment 300 performs the tasks without user interaction and without modifying the configuration file 124. The embodiment 300 may be use for performing a reinstallation of a system on a device or for creating a duplicate installation on a second device. In some instances, a configuration file from a first successful installation may be used to recreate an identical installation on another device.

Within the storage 127 are several configuration files 128. The version management system 130 may interact with the configuration files 128 to determine a configuration file 124 from a successful installation on a first device. The silent setup manager 202 may take the setup tasks 104 in a sequence file and the configuration file 124 to perform the tasks 106, 108, and 110 without user interaction.

Since the tasks 106, 108, and 110 are data driven and do not have a user interface, each of the tasks may be executed with the data from the configuration file 124 without user interaction. The silent setup manager 202 may be able to repeat an identical installation process on the same device as originally performed or on a second device.

By performing the installation process on the same device as previously completed, the silent setup manager may-be able to restore a system to an installed state if a problem had occurred. When the installation process is performed on a second device, the second device may be configured identically as a first device. Such a duplication may be performed without having a user enter any data, which may error prone as well as tedious.

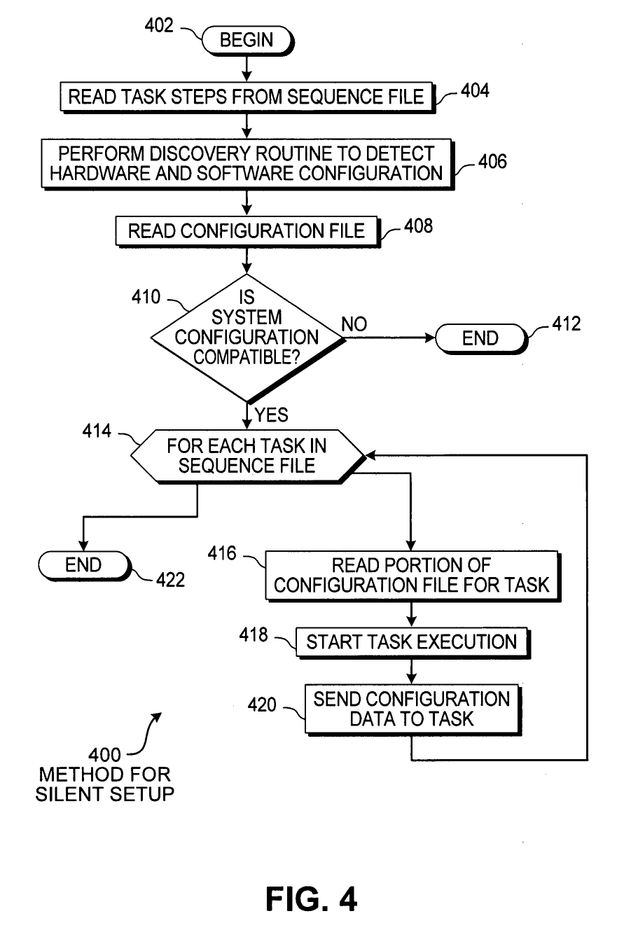

FIG. 4 is a flowchart illustration of an embodiment 400 showing a method for silent setup. Embodiment 400 is similar to embodiment 200 except that the setup sequence is performed without user interaction.

The process begins in block 402, and task steps are read from a sequence file in block 404. A discovery routine is performed in block 406 to detect hardware and software configuration. The configuration file is read in block 408.

In block 410, if the system configuration from the detection routine in block 406 is not compatible with the configuration file in block 408, the process ends in block 412. If the detected configuration is compatible with the configuration file in block 410, the following process is performed.

For each task in the sequence file in block 414, the portion of the configuration file for the task is read in block 416, the task is begun in block 418, and configuration data is sent to the task in block 420. After each task is performed, the process ends in block 422.

Embodiment 400 performs a discovery routine in block 406 to determine if the device which is to be configured is compatible with the planned installation. In some embodiments, the discovery routine 406 may be used to ensure that proper hardware and software components are installed on a device prior to performing the silent setup. In other embodiments, the silent setup may be performed without a discovery routine.

Embodiment 400 may be performed when a configuration management system 132 detects a change in the configuration of hardware or software on a device. For example, a configuration management system 132 may be process on a personal computer that monitors the hardware and software status of the personal computer. When a change is detected, such as the personal computer is restarted and the graphics card on the computer has been changed to an advanced graphics card, the configuration management system may cause embodiment 400 to be performed, using the new graphics card data as input to one or more of the various tasks. In such a manner, the configuration management system may modify various settings on a device by automatically performing a reinstallation of some or all of the installation tasks.

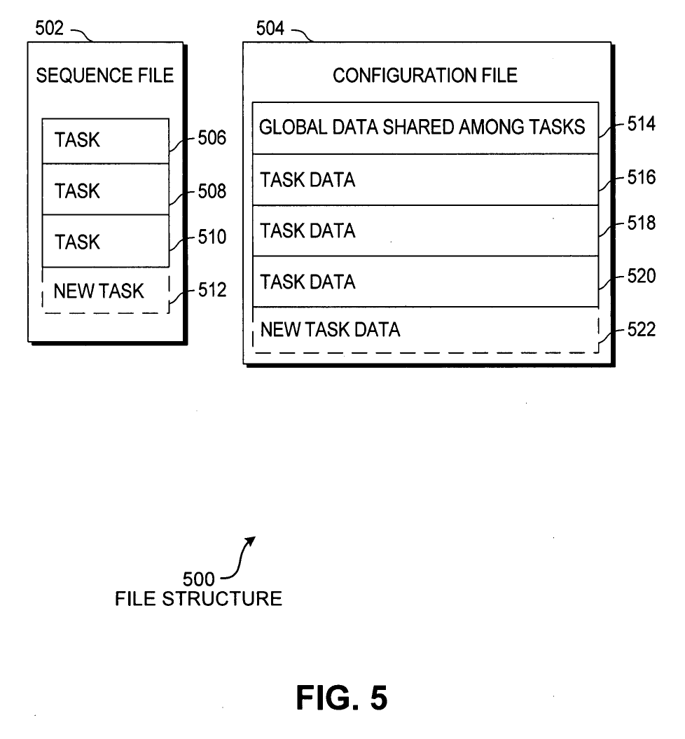

FIG. 5 is a diagram illustration of an embodiment 500 showing a file structure. A sequence file 502 and configuration file 504 are illustrated.

The sequence file 502 contains a listing of tasks 506,508,510, and anew task 512. The configuration file 504 contains global data shared amongst tasks 514, as well as task data 516, 518, 520, and new task data 522.

Embodiment 500 is a diagram representation of a file structure that may be used for defining sequences of tasks as well as configuration data for the tasks. Each file may be in any type of format, including human-readable formats such as XML.

In some embodiments, a task may be added to a setup or installation procedure by adding the appropriate task information to the sequence file 502 and the configuration file 504. In some embodiments, tasks may be added after installation of several tasks has been performed. In such a case, an additional task may be added to the files 502 and 504 and the task performed without having to redo the previous tasks.

In other embodiments, a task may be added to a setup or installation procedure by a product developer to extend or modify the setup procedure for a specific application. Because the tasks may be created in a modular fashion, different tasks may be added or removed to address specific installation procedures. Such a system may be used when deploying several different versions of a complex software application or suite of applications.

Tasks may be added to a setup sequence by third party developers that may add specific functionality or extensions to a software application. When the sequence file 502 and 504 are made available to third party developers, the developers may add their portions to an installation routine simply and easily, while having the entire installation process be controlled by a single setup manager.

In some instances, tasks may be added to a sequence file 502 and configuration file 504 that are not related to other tasks. For example, a sequence file 502 may define a sequence for installing an operating system and a suite of business applications. An additional task 512 may be added with accompanying data 522 to add the installation task of a flight simulator game to the system. The additional task may be managed under a single setup manager along with the other components and applications on a device.

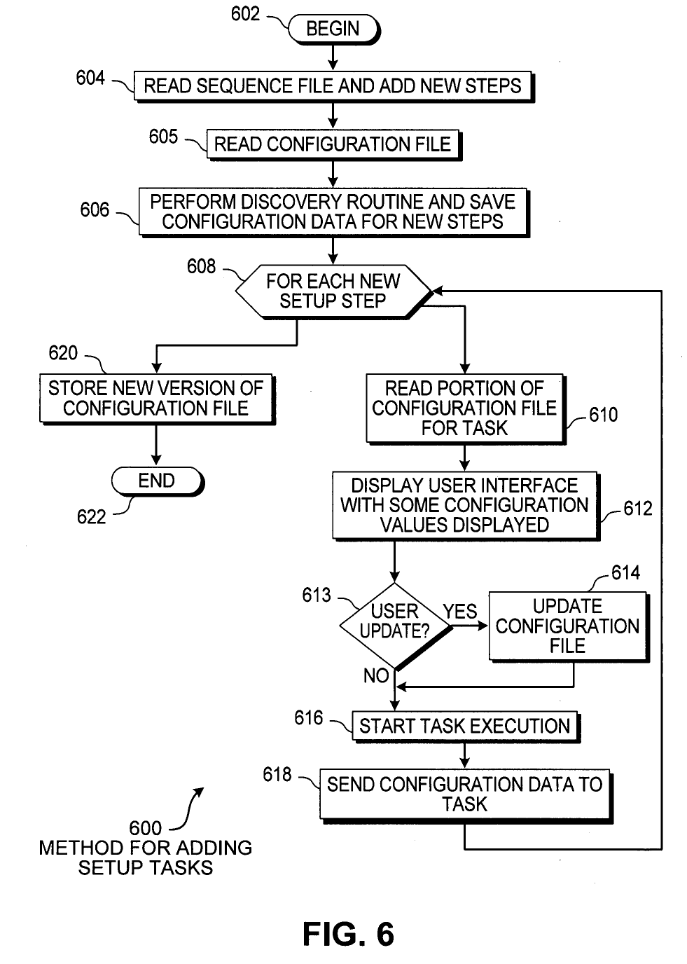

FIG. 6 is a flowchart illustration of an embodiment 600 showing a method for adding a setup task. Embodiment 600 is a method by which a new setup step may be added to a sequence file and configuration file and perform the new steps on a device. Embodiment 600 may be used, for example, to install an additional software component to a device and keep the device configuration defined in a configuration file so that a reinstall or duplication of the device may be performed in a single execution of a sequence of tasks. Embodiment 600 does not perform previous tasks over again, but performs the new tasks and appends the new task information to existing sequence and configuration files.

The process begins in block 602. A sequence file is read in block 604 and new steps are added in block 604. A configuration file is read in block 605 and a discovery routine is performed in block 606 and configuration data is saved for the new steps.

For each new setup step in block 608, the following process is performed. A portion of the configuration file is read for the task in block 610. A user interface is displayed in block 612 with some of the configuration values displayed. If the user updates the data in block 613, the configuration file is updated in block 614. The task is executed in block 616 and configuration data for the task is sent to the task in block 618.

After all of the new tasks are performed in block 608, a new version of the configuration file is stored in block 620 and the process ends in block 622.

Embodiment 600 is similar to embodiment 200 in that a user interface is used to update any data that may be required for the new tasks added to the task sequence. A discovery routine may or may not be used in some embodiments to generate a preliminary set of configuration data for the new tasks. In some instances, a new task may be supplied with a set of default settings that a user may edit, modify, or accept. Some tasks may be supplied with no user editable variables and thus may not require a user interface or user input to change variables.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
defining a series of setup tasks, each of said setup tasks having a data input, said setup tasks comprising an installation process for a first device; and
for at least one of said setup tasks, perform a first method comprising:
reading at least a portion of a first configuration file for said setup task to receive task input data;
displaying a user interface comprising at least a portion of said task input data;
receiving an update from said user interface comprising an update to said task input data;
updating said task input data;
storing said task input data in a second configuration file; and
starting said setup task using said second configuration file.

2. The method of claim 1 further comprising:
performing a discovery routine adapted to determine configuration data about said first device and store said configuration data in said first configuration file.

3. The method of claim 2, said configuration data comprising at least one of a group composed of hardware configuration data and software configuration data.

4. The method of claim 1 further comprising:
performing said installation process on a second device by executing said series of setup tasks using said second configuration file.

5. The method of claim 1 further comprising:
comparing said second configuration file and a third configuration file to determine at least one difference.

6. A computer readable medium comprising computer executable instructions adapted to perform said method of claim 1.

7. A system comprising:
a task sequence file comprising a series of setup tasks, said setup tasks comprising an installation sequence;
for each of said setup tasks, at least one task file adapted to operate with input data and perform at least a portion of a setup function;
a first configuration file comprising input data for each of said setup tasks; and
a setup engine adapted to perform said series of setup tasks by a method comprising starting one of said task files and transmitting a portion of said first configuration file to said task file.

8. The system of claim 7 further comprising a discovery tool adapted to determine configuration data about a first device and store said configuration data in a raw configuration file.

9. The system of claim 8, said configuration data comprising hardware configuration data.

10. The system of claim 8, said configuration data comprising software configuration data.

11. The system of claim 7 further comprising a user interface adapted to:
read a portion of said configuration file;
display said portion in said user interface;
receive an updated portion of said configuration file from a user; and
store said updated portion in a second configuration file.

12. The system of claim 7, said installation sequence comprising installation steps for at least a portion of an operating system.

13. The system of claim 7, said installation sequence comprising installation steps for at least a portion of an application.

14. The system of claim 7, at least one of said task files being an executable file.

15. The system of claim 7, at least one of said task files being a script file.

16. A method comprising:
defining a first series of setup tasks, each of said setup tasks having a data input, said setup tasks comprising an installation process for a first device;
for at least one of said setup tasks, perform a first method comprising:
reading at least a portion of a first configuration file for said setup task to receive task input data;
displaying a user interface comprising at least a portion of said task input data;
receiving an update from said user interface comprising an update to said task input data;
updating said task input data;
storing said task input data in a second configuration file; and
starting said setup task using said second configuration file;
installing a new component on said first device using a first task file using first configuration data;
adding said new component to said series of setup tasks to create a second series of setup tasks;
adding said first configuration data to said second configuration file to create a third configuration file; and
storing said third configuration file.

17. The method of claim 16 further comprising:
using said third configuration file to perform said second series of setup tasks.

18. The method of claim 17 further comprising:
performing said second series of setup tasks on a second device.

19. The method of claim 17 further comprising:
performing a discovery routine adapted to determine configuration data about said first device and store said configuration data in said first configuration file.

20. A computer readable medium comprising computer executable instructions adapted to perform said method of claim 17.
